(19) United States
(12) Patent Application Publication
(10) Pub. No.: US 2023/0342844 A1
(43) Pub. Date: Oct. 26, 2023

(54) METHOD, SYSTEM, AND APPARATUS FOR MULTIPLE LOAN RETRIEVAL AND SIMULTANEOS PRESENTATION

(71) Applicant: Tire Agent Corp., New York, NY (US)

(72) Inventors: Franco Cappitta, New York, NY (US); Jared Kugel, New York, NY (US)

(21) Appl. No.: 17/727,268

(22) Filed: Apr. 22, 2022

(51) Int. Cl. G06Q 40/02; H04L 9/40

(52) U.S. Cl. CPC G06Q 40/025; H04L 63/0838

(57) ABSTRACT

The method, system, and apparatus for multiple loan retrieval and simultaneous presentation to a user allows the user to seek a plurality of loans with accompanying terms from a plurality of lenders. The method, system, and apparatus is advantageous to the user because of the objective benefit of having a wider selection of choice of loans and terms, and the ability for the user to sort, compare, and select a particular loan and terms, based on the user's subjective preferences, when the user desires to purchase a durable good during a purchase workflow on an ecommerce platform.

### FIELD OF THE INVENTION

The present invention generally relates to a system, a method, and an apparatus that collects information from a user, requests loan approvals with terms from a plurality of lenders based on the collected information, presents all approved loans and terms from the plurality of lenders to the user and, more particularly, provides the user with a graphical user interface for easy analysis, comparison, and selection from among the approved loans and terms.

### BACKGROUND OF THE INVENTION

Many organizations and services use a specialized application or access a website through an internet browser to provide users desiring to purchase a durable good with a method to secure a loan from a lender. Typically, such applications and websites require the user to fill in personal identifiable information regarding a set of criteria that is forwarded by the application or website to the lender. That lender decides whether to approve or deny the user's request for the loan through computations and/or algorithms of their choosing; then, the lender returns the lender's approval with terms of the loan or the lender's denial of the request to the application or website. If a denial is received, many systems forward the user's information to another lender for the same approval/denial and terms query until a subsequent lender provides the application or website with approved terms for a loan for the user's desired purchase. Then, in most cases, the user decides to whether to accept the lender's approved loan terms and fills in any supplemental information to secure the loan for the durable good. This method of providing the user with usually one or two loan options from a small number of lenders may be undesirable for the user who often seeks a preferred repayment structure whether that be lower payments, a lower percentage of interest, a grace period length before repayment begins, etc. Therefore, there is a long-felt need for a system, a method, and an apparatus which provides the user with a multitude of potential loans and terms for those loans from a plurality of lenders. Additionally, there is a long-felt need for a system, a method, and an apparatus that provides the user with graphically pleasing and easy-to-read terms of a loan. Further, there is a long-felt need for an easy-to-use system, method, and apparatus that allows the user to compare different loans and their terms from the same lender or a plurality of lenders.

### SUMMARY OF THE INVENTION

The following presents a simplified summary of the present invention to provide a basic understanding of the invention's concepts. This summary is not an extensive overview, and it is not intended to identify critical elements or to limit the scope of this discloser. The sole purpose of this summary is to present some general concepts in a simplified form as a prelude to the detailed description of the invention.

The subject matter disclosed and claimed herein, in some embodiments of the present invention, relates to a computer implemented method for simultaneous and multiple loan decision retrieval and presentation to a user who desires to complete a purchase workflow on an ecommerce platform, performing, by at least one computer processor, a security authentication check to confirm the user's identity and establish a contact method for that user, sending at least one set of questions that the user must answer, receiving at least one answer set corresponding to the at least one set of questions that was sent to the user, storing the at least one answer set on a computer storable memory medium, sending the at least one answer set and details of the user's desired purchase to a plurality of lenders that determines loan eligibility and terms based on information provided by the user in the at least one answer set, receiving the loan application status and terms from the plurality of lenders within a predetermined timeframe, generating, by at least one computer processor, a list showing all approved loan applications with corresponding terms, receiving the user's selected loan and terms, forwarding the user to the lender's loan processing portal corresponding to the loan and terms the user selected, receiving a lender confirmation that corresponds to the user's acceptance of the loan and terms and the lender's approval of the user's acceptance, receiving a submission by the user of a purchase confirmation, and sending the purchase confirmation to the ecommerce platform that the user has secured a loan for payment for the purchase workflow.

The subject matter disclosed and claimed herein, in another embodiment of the present invention, relates to a computer system for simultaneous and multiple loan decision retrieval and presentation to a user who desires to complete a purchase workflow on an ecommerce platform including at least one computer processor and a program memory storing executable instructions that when executed by at least one computer processor causes the computer system to perform, by at least one computer processor, a security authentication check to confirm the user's identity and establish a contact method for that user, send at least one set of questions that the user must answer, receive at least one answer set corresponding to the at least one set of questions that was sent to the user, store the at least one answer set on a computer storable memory medium, send the encrypted at least one answer set and details of the user's desired purchase to a plurality of lenders that determines loan eligibility and terms based on information provided by the user in the at least one answer set, receive the loan application status and terms from the plurality of lenders within a predetermined timeframe, generate, by at least one computer processor, a list showing all approved loan applications with corresponding terms, receive the user's selected loan and terms, forward the user to the lender's loan processing portal corresponding to the loan and terms the user selected, receive a lender confirmation that corresponds to the user's acceptance of the loan and terms and the lender's approval of the user's acceptance, receive a submission by the user of a purchase confirmation, and send the purchase confirmation to the ecommerce platform that the user has secured a loan for payment for the purchase workflow.

The subject matter disclosed and claimed herein, in another embodiment of the present invention, relates to a non-transitory computer-readable storage medium comprising computer-readable instructions to be executed by at least one computer processors of a system for simultaneous and multiple loan decision retrieval and presentation to a user, the instructions when executed causes at least one computer processor to perform, by at least one computer processor, a security authentication check to confirm the user's identity and establish a contact method for that user who desires to complete a purchase workflow on an ecommerce platform, receive at least one answer set corresponding to at least one set of questions provided to the user, store the at least one answer set on a computer storable memory medium, send the encrypted at least one answer set and details of the user's desired purchase to a plurality of lenders that determines loan eligibility and terms based on information provided by the user in the at least one answer set, receive the loan application status and terms from the plurality of lenders within a predetermined timeframe, generate, by at least one computer processor, a list showing all approved loan applications with corresponding terms, receive the user's selected loan and terms, forward the user to the lender's loan processing portal corresponding to the loan and terms the user selected, receive a lender confirmation that corresponds to the user's acceptance of the loan and terms and the lender's approval of the user's acceptance, receive a submission by the user of a purchase confirmation, and send the purchase confirmation to the ecommerce platform that the user has secured a loan for payment for the purchase workflow.

To the accomplishment of the foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 is a diagram of an exemplary method used in some embodiments of the present invention.

FIG. 2 is a flow diagram of an example of a security authentication check used in some embodiments of the present invention.

FIG. 3 is a diagram of an exemplary configuration of the system and apparatus of some embodiments of the present invention.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

Consumers, who have always desired to receive the best durable good at the best price, have continued to become more sophisticated and seek better loan or financing (collectively “loan” in the singular or “loans” in the plural) offers and terms than what may be immediately available at a retail checkout, dealership office, or purchase workflow on an ecommerce platform. Consumers often seek to secure loans for durable goods such as automobiles, computers, tools, HVAC units, furniture, etc. Many traditional stores as well as ecommerce platforms may offer, either directly or as an intermediary, such loan options during a checkout or purchase workflow. Often these retail stores, dealerships, and ecommerce platforms are associated with one or two lending partners, or they have a preference for the order in which they attempt to secure loans for the consumer. This arrangement often leads to the retail stores, dealerships, or ecommerce platforms preferring lending partners that provide advantages (such as reduced rates or fees on their own loans, incentive bonuses for referring the consumer, etc.). Such an arrangement often fails to produce the best price and/or loan terms for the consumer.

One reason that such an arrangement may not provide the consumer with a loan with the best terms is because not every lending partner values the individual responses on the consumer's application for a loan the same. Additionally, many lending partners check the consumer's credit report and/or FICO score based on information supplied in the application and evaluate that information with the consumer's other answers in the application to generate loan with terms for the consumer to review. Naturally, the more lending partners that are provided with the consumer's information, the more likely the chance that the consumer will receive the best loan and terms. Although, the “best” loan offer and terms is subjective to that consumer. Just like the lending partners may evaluate the consumer's application and credit report, the consumer may also evaluate different variables in the loan terms. Some such variables that the consumer may be evaluating include the number of installments, the frequency of payments, a grace period before repayment begins, the amount of the payment, early payoff fees, and more.

Therefore, it is beneficial to the consumer to receive a larger number of offers for loans with different terms from a plurality of lenders. This benefit is not just because it increases the chance for the consumer to receive the objective best terms from one of the lenders, but also the consumer's subjective preferred terms as well. Further, while it is not practical to seek offers and terms from every possible lender for a specific durable good, current methods, systems, and apparatuses typically only initially seek offers and terms from a small number of lenders (typically one to three lenders). And, if those initially sough lenders deny the application, then then method, system, or apparatus sometimes attempts to seek offers and terms from another small number of lenders. This is sometimes referred to as “waterfall” loan generation because it contacts lenders in succession and the process can be time-consuming for the consumer. Therefore, there is a long-felt need for a loan generating and presentation method, system, and apparatus that provides the consumer with a plurality of loans with terms for the consumer's review so that the consumer receives both objective and subjective better loan and term options. Further, there is a long-felt need for a method, system, and apparatus that allows the customer to quickly sort, compare, and select their desired loan the terms.

In general, the present invention can be embodied in a method, a system, or an apparatus for simultaneous and multiple loan decision retrieval and presentation to a user who desires to complete a purchase workflow on an ecommerce platform. More specifically, in some embodiments, the present invention involves exchanging of data and information and includes performing a security authentication check; storing the user's answers; performing a verification on the goods the user is purchasing, the user's answer set, and the loan and terms; and providing the user with a graphical user interface that includes sorting, comparison, and selection tools for the loans and terms.

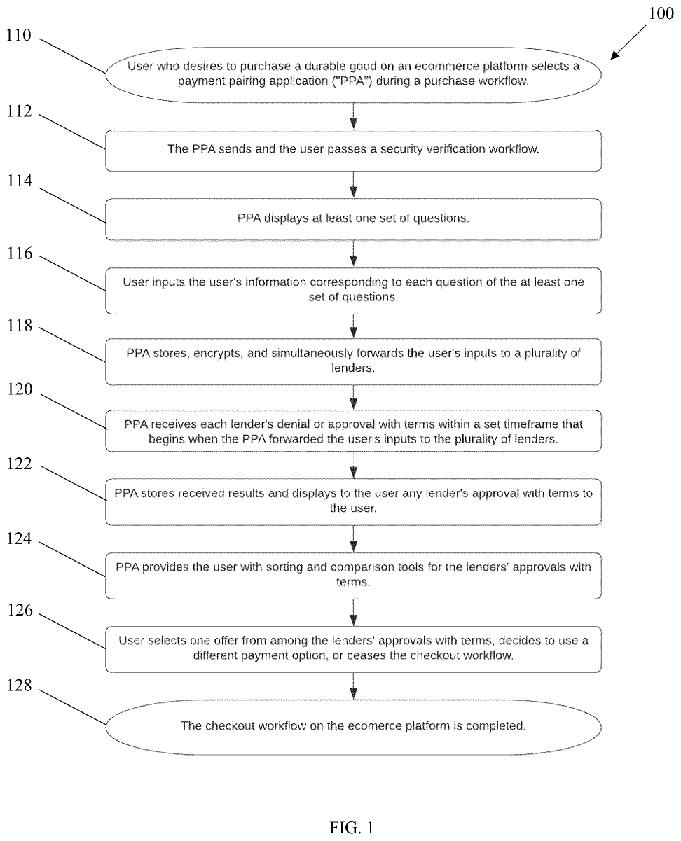

FIG. 1 is a diagram of one embodiment of a computer implemented method for simultaneous and multiple loan decision retrieval and presentation to a user 100. In the displayed embodiment, a user who desires to purchase a durable good on an ecommerce platform selections a payment pairing application (“PPA”) during the purchase workflow 110. The user may be an individual, legal entity, business, or other organization. The PPA may be an application on a cell phone or computer, accessed by a website on the internet either as a standalone platform or partnered with and available through the ecommerce platform and available during the purchase workflow, an application extension in the user's browser, or other suitable programs, applications, or software which generally collects the user's information, stores and/or sends that information to at least one lender, receives correspondence from the at least one lender, displays that correspondence to the user, and allows the user to secure a loan from their preferred lender. The PPA may be owned by an organization, company, or individual which seeks to facilitate the method for simultaneous and multiple loan decision retrieval and presentation to the user 100. The purchase workflow may be in the form of a cart or checkout page or workflow, or any other method of completing a purchase on the ecommerce platform. After initiating use of the PPA in the purchase workflow, the PPA sends and the user must successfully complete a security verification check 112. The PPA interacts with the user through a graphical user interface on the user's device. The graphical user interface may have a plurality of forms and windows which facilitate the methods for simultaneous and multiple loan decision retrieval and presentation to the user 100. This workflow may require the user to verify their phone number or email address. This can be accomplished through various methods such as generating a one-time password and sending it to the user's cellular phone or email and requiring the user to input that one-time password into a field on the PPA. Other methods for the security verification check includes calling the user's phone number to confirm their identity, requiring the user to fill out a form requesting personal identifiable information (“PII”), and requesting the user's bank or credit card information. If the user fails the security verification workflow, the user is shown an error message and may be offered the ability to attempt the workflow again.

After the security verification workflow is successfully completed, the PPA displays at least one set of questions 114. These questions may collect PII and other necessary information or data to supply the lenders the information they need for their determination of whether to offer the user a loan and the terms of that loan. Further, in some embodiments, the information or data collected in the at least one set of questions may be directly sent to a credit bureau, background checking service, or other resource that is able to provide information about the user. The user inputs the user's information corresponding to each question of the at least one set of questions 116 in order to proceed with the purchase workflow. In some embodiments the PPA stores, encrypts, and simultaneously sends the user's at least one answer set to a plurality of lenders 118. The PPA may store the user's answer set either locally on the user's device or on a separate medium such as a server owned by the PPA's owner or in cloud storage. While storing the user's answer set, the data may be reformatted and/or placed into a database. For the user's safety and privacy, the PPA encrypts the user's information before transmitting it to a centralized server, cloud server, or to the lenders. The PPA sends out the user's information to the plurality of lenders in relatively the same span of time. Meaning that the user's information is sent to the plurality of lenders before the PPA receives confirmation of any lenders receipt of the user's information or decision on loan eligibility with any accompanying terms for that loan.

In alternative embodiments, after storing and encrypting the user's at least one answer set, the PPA sends the user's encrypted at least one answer set to at least one credit bureau (or similar authority or entity) and request credit information from each credit bureau corresponding to that user. Each request from the PPA to the corresponding credit bureau should receive credit information for the user which may include information such as a user's FICO score, past credit events, debt-to-income ratio, etc. The PPA may store and encrypt a user's credit information. Once the PPA has the user's credit information, the PPA may use a sorting method or algorithm to format the data received from each credit bureau into a desired format such as an indexable and searchable file and/or table.

Further embodiments may include a minimum credit check criteria algorithm that inputs the sorted user's credit information into the algorithm to determine whether the user qualifies to have their data sent to the plurality of lenders to request a loan eligibility decision with terms. The PPA may determine, by the minimum credit check criteria algorithm, that the user does not meet the minimum criteria and deny the user the opportunity to have their information sent to the plurality of lenders. The minimum credit check criteria may be based on a weighted scale of factors, the user's FICO score, number of past and/or recent credit events, existence of bankruptcy or other credit impacting actions, any other criteria, and combinations thereof. If the user is fails to meet the minimum credit check criteria, the PPA, through the graphical user interface, may deny the user the opportunity to have their information sent to the plurality of lenders. In some embodiments, such failure and/or denial may be accompanied, through the graphical user interface, with confirmation of such denial and present the user with a plurality of traditional payment options such as entry fields for a credit card, store card, debit card, or provide some other payment gateway to complete the purchase workflow. A similar denial may occur elsewhere in the purchase workflow based on information provided by the user or other sources. Anytime such a total denial of loans with terms is determined by the PPA, the user may be presented with the plurality of traditional payment options.

In some embodiments, the lenders may individually use different algorithms, processes, or other methods to determine the user's loan eligibility and the terms of the loan. The lenders' activities may include a credit check or FICO score check with another party. This credit check may be performed whether the PPA already requested and received information from the credit bureaus. Although, in ideal embodiments, the information received by the PPA should remove the need or expedite the lenders credit check methods. The user is advantaged by having the PPA gather the user's credit information from the at least one credit bureau and sending that data with the user's other information to the plurality of lenders. One advantage is that there will likely be less recent events posted on the user's credit history so long as the plurality of lenders are not also requesting information from those same credit bureaus. These recent events are sometimes referred to as soft pulls or hard pulls, depending on the reason and type of data requested, in the credit/lending industry. Another advantage is that the lenders do not need to take the time to perform their own credit checks thanks to the information provided by the PPA.

The lenders' individual processes do not particularly matter; all that matters for the present invention is that the PPA sends the user's information to the lender and that the lender returns the loan eligibility decision with terms for approved loans within a set timeframe. The PPA receives each lender's denial of the loan request or approval of said loan request with accompanying loan terms 120. The PPA, in an effort to make the process desirably quick for the user, sends the user's information to the plurality of lenders and receives the lenders' responses within a set timeframe. Similar to the user's information, the PPA stores the lenders' responses and displays, through the PPA's graphical user interface on the user's device, all received lenders' approved loans with accompanying loan terms 122. The default display of the loans could be based on number of payments, total loan amount, by lender, or any other arbitrary or desired configuration. In some embodiments, the PPA's graphical user interface includes sorting and comparison tools. These tools allow the user to sort and compare the lenders' loans and terms 124. For example, the user could sort and/or compare the loans based on the form of interest (such as fixed interest, APR, compound interest, etc.), the frequency of payments, the total number of payments, the total repay amount, whether there are early payoff fees, the date of the first payment, by lender, etc.

Next, the user may select from the approved loans and terms, decide to use a different payment method such as a credit card or store card, or the user may decide not to cease the transaction and exit the purchase workflow 126. In some embodiments, if the user selects a particular loan and terms to complete the purchase workflow, the PPA resends the user's information to the corresponding lender of that loan and terms to verify that the information from the user and from the lender is accurate before proceeding with the completion of the purchase workflow. This reverification severs the purchase of checking for any potentially errors with the user's information, its encryption and transmission, and from the process and response of the lender. Additionally, this reverification sends any updates to the user's information and/or additions to the user's desired purchase (such as items in the user's cart that may not have previously submitted to the lender). With the loan secured from the lender, the user is able to complete the purchase workflow on the ecommerce platform 128.

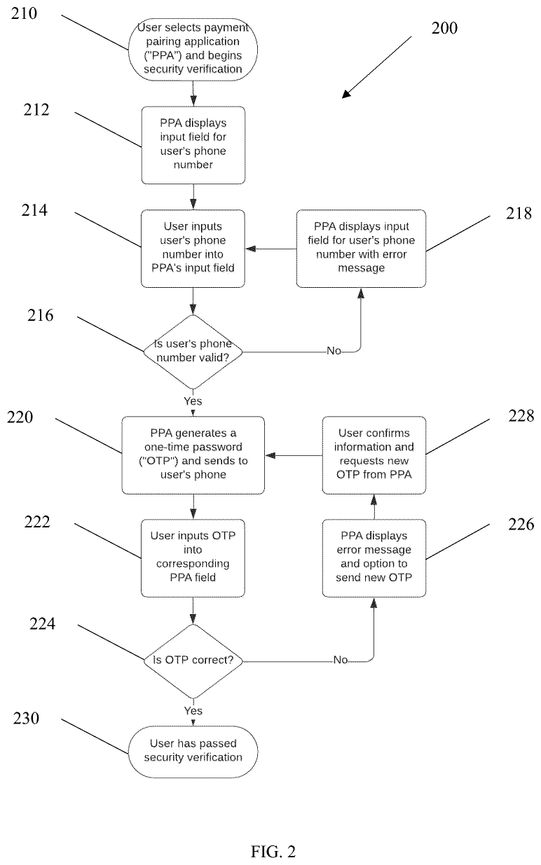

FIG. 2 is a flow diagram of an example of a security authentication check 200 used in some embodiments of the present invention. The security authentication check 200 begins after the user selects the PPA to assist in securing a loan for the completion of the purchase workflow 210. The PPA displays an input field and request for the user to input their phone number 212. The PPA may display, at the same time, information regarding text messaging fees or other disclaimers that the user should read before the user proceeds with the security verification check 200. The presence of instructions notifying the user that they will receive a text message is an indication that a landline phone number, without text messaging, will not suffice to complete the security authentication check 200. Having read any disclaimers or instructions, the user inputs their phone number into the PPA's input field 214. The PPA and/or related service or server checks that the user has input a valid phone number 216. If the user has not input a valid phone number, the PPA again displays a input for the user's phone number with an additional error message informing the user of the issue with the previous phone number 218. Issues with the previous phone number include an incorrect number of digits in the phone number, the phone number being disconnected, the phone number being incapable of receiving text messages, the phone number being block by the PPA's service or a third party, or any other reason that would prevent the phone number and assigned device from receiving the message from the PPA's service or partner service used for the security authentication check 200.

In some embodiments, the PPA generates a one-time password and sends it to the user's provided phone number via SMS (text message) 220. These one-time passwords sent via SMS are most commonly generated based on a variety of algorithms which may be based on the generating computer's clock, the user's phone number, a random counter, a chain based on previous one-time passwords that have been generated (a hash chain), or other suitable method known in the art. Further, many cellular phones and their associated server providers includes encryption of a digital certificate which is used for authentication. Once received, the user inputs the one-time password into the corresponding field in the PPA 222. In some embodiments, the one-time password may be copy and pasted into the corresponding field in the PPA for speed and convenience. Other embodiments of the PPA's corresponding field may disallow the user to copy and paste the one-time password for security concerns. The PPA determines whether the one-time password is correct 224. This may be accomplished by the PPA on the user's device or by another device such as a server. If the one-time password is incorrect, the PPA displays an error message and the option to send another one-time password to the user 226. This option may additionally allow the user to change their desired phone number or to cancel the purchase workflow. The user confirms the information (particularly the phone number) is correct and requests that the PPA generate and send a new one-time password 228. If the one-time password is correct, the user is deemed to have passed the security authentication check and continues the method for simultaneous and multiple loan decision retrieval and presentation to the user 100.

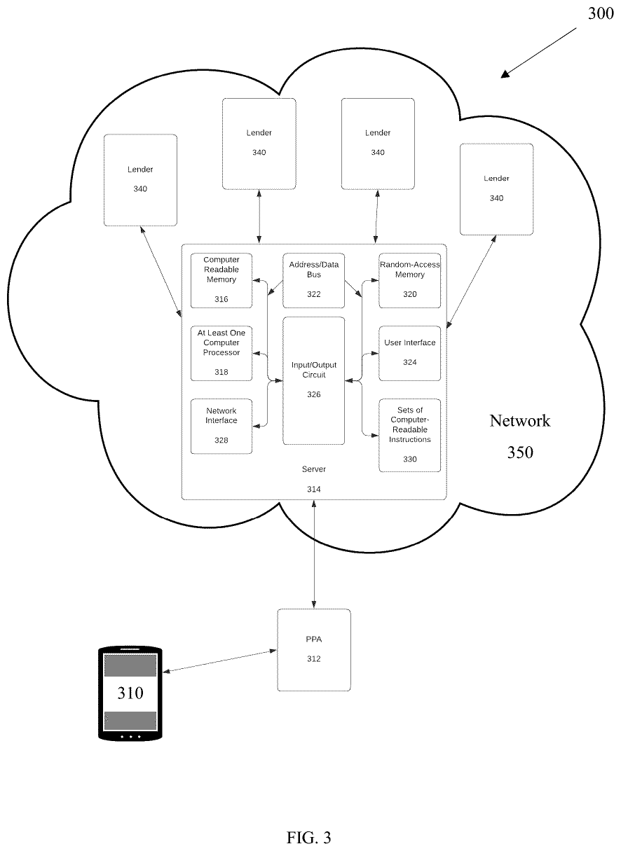

FIG. 3 shows a diagram of an exemplary configuration of the system of one embodiment of the present invention. A system for simultaneous and multiple loan decision retrieval and presentation to a user 300 includes a user's device 310, a PPA on the user's device 312, the PPA 312 connected to a server 314 via a network 350. Some examples of the user's device include a cellular phone, a tablet, a computer, or any other device that the PPA 312 may be installed on. The PPA 312 uses the resources of the user's device, displays information to the user, and facilitates interactions with the user through the graphical user interface and the input/output mechanisms of the user's device. Input/output mechanism includes a touch screen, physical keyboard, voice recognition and typing, and other methods known in the art. The PPA 312 communicates with the server 314 via a network 350. The server 314 includes computer readable memory (often referred to as “program memory” or “memory”) 316, at least one computer processor (sometimes referred to as a controller, a microcontroller, or a microprocessor) 318, a random-access memory (“RAM”) 320, an address/data bus 322, a user interface 324, an input/output (“I/O”) circuit 326, a network interface 328, and multiple sets of computer-readable instructions 330. All of the components of the server 314 are interconnected via the address/data bus 322. The memory 316 may comprise one or more tangible, non-transitory computer-readable storage media or devices, and may be configured to store computer-readable instructions that, when executed by the at least one computer processer 318, cause the server 314 to implement the system for simultaneous and multiple loan decision retrieval and presentation to a user 300.

Memory 316 may store multiple sets of computer-readable instructions 330 and organize them into modules that can be executed to implement the system for simultaneous and multiple loan decision retrieval and presentation to a user 300. In one embodiment, the memory 316 stores multiple sets of computer-readable instructions 330 that cause the server 314 to send and receive data to and from the PPA 312, generate a one-time password and send it to the user's phone number for a security authentication check 200, store the user's information, encrypt the user's information, send the encrypted user's information to at least one lender 340 (each lender 340 in the diagram representing a separate lender and collectively a plurality of lenders), receive the loan eligibility and accompany terms from each lender 340, send the approved loans and terms to the PPA 312 on the user's device 310, perform a verification check before allowing the user to complete the purchase workflow, confirm to the loan to the lender 340 after the user completes the purchase workflow, and mine text stored on the memory 316. The memory 316 may store fewer or additional sets of computer-readable instructions on the server 314 in accordance with the necessities of the system for simultaneous and multiple loan decision retrieval and presentation to a user 300. Computer-readable instructions include executable features that cause the computer to generate, receive, send, verify, compute, or otherwise perform some computation to aid in furthering the purpose of the present invention. In some embodiments, the computer-readable instructions 330 may be stored as processes, scripts, applications, and/or modules. In some embodiments, the computer-readable instructions 330 may be stored as routines, subroutines, or other blocks of instructions.

The server 314 may be operatively connected to send and receive communications, data, requests, and/or responses over the network 350 via the I/O circuit 326 and network interface 328. The server 314 may connect to the network 350 at the network interface 328 via a wired or wireless connection, or other suitable communications technology. The network 350 may be one or more private or public networks. The network 350 may be a proprietary network, a secure public internet, a virtual private network, a cellular/mobile network, or some other type of network, such as dedicated access lines, plain ordinary telephone lines, satellite links, combinations thereof, etc. Where the network 350 comprises the Internet, data communications may take place over the network 350 via an internet communication protocol. Data is exchanged between the user's device 310, the PPA 312, the server 314, and the lenders 340 via the network 350.

The server 314 may receive the user's information from PPAs 312 on one or more of the user's devices 310 via the network 350. The server 314 may also request data or information from PPAs 312 on one or more of the user's devices 310 via the network 350. In alternative embodiments of the present invention, the PPA 312 on the user's device 310 may communicate directly with the plurality of lenders 340 via the network 350. Additionally, the server 314 may send, receive, and request data and information from the plurality of lenders 340 via the network 350.

In some embodiments of the present invention, an agent of the organization that owns and/or runs the PPA 312 may receive the user's information directly from the user via a phone call, face-to-face meeting, or other method. That agent may input the user's data directly into the server via a user interface 324 or through a PPA 312 to the server 314 via the network 350. The user interface 324 may be a remote user-interface at a remote computing device, such as a webpage or client application.

In some embodiments, the memory 316 may include a database that may be configured to adapted to store data related to the system for simultaneous and multiple loan decision retrieval and presentation to a user 300. The database may be used to store various data and information, including information about the user (including PII), information received from the user, information about the durable good that the user desires to purchase, loan performance data, information received from the lenders, information regarding the terms of the loans, credit bureau data, web traffic metrics, geographic data from the user's device 310, data regarding a specific lender's turnaround time for determining loan eligibility, and/or any other data or information that is measurable and/or recordable through the use of the system for simultaneous and multiple loan decision retrieval and presentation to a user 300. Alternatively, the database may not be located within the memory 316 of the server 314 and may be located remotely or within a cloud storage service.

Although the components of the server 314 are shown in single blocks in the diagram, it should be understood that the memory 316, RAM 320, I/O circuit 326, and other components may be made up of multiple, a set, or a series of those components. For example, there may be several RAM 320 components (sometimes called “RAM sticks”) installed within the server 314.

It should be understood that “user” as used in this disclosure means the individual, legal entity, business, or organization seeking to secure the loan for the purchase of the durable good. The user may be referred to as the user, the customer, the consumer, the lendee, or other indication of being the person, entity, business, or organization that desires to secure the loan. The user is still the referred to user when an intermediary, such as an assistant, disability aide, salesman or representative, or other individual or organization assists the user in completing the responses to the sets of questions and submit that information via the PPA.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented method for simultaneous and multiple loan decision retrieval and presentation to a user who desires to complete a purchase workflow on an ecommerce platform comprising:
performing, by at least one computer processor and via a graphical user interface, a security authentication check to confirm the user's identity and establish a contact method for that user;
sending, by at least one computer processor and via the graphical user interface, at least one set of questions that the user must answer;
receiving, by at least one computer processor and via the graphical user interface, at least one answer set corresponding to the at least one set of questions that was sent to the user;
storing, by at least one computer processor, the at least one answer set on a computer storable memory medium;
sending, by at least one computer processor, the at least one answer set and details of the user's desired purchase to a plurality of lenders that determines loan eligibility and terms based on information provided by the user in the at least one answer set;
receiving, by at least one computer processor, the loan application status and terms from the plurality of lenders within a predetermined timeframe;
generating, by at least one computer processor and via the graphical user interface, a list showing all approved loan applications with corresponding terms;
receiving, by at least one computer processor and via the graphical user interface, the user's selected loan and terms;
forwarding, by at least one computer processor, the user to the lender's loan processing portal corresponding to the loan and terms the user selected;
receiving, by at least one computer processor, a lender confirmation that corresponds to the user's acceptance of the loan and terms and the lender's approval of the user's acceptance;
receiving, by at least one computer processor and via the graphical user interface, a submission by the user of a purchase confirmation; and
sending, by at least one computer processor, the purchase confirmation to the ecommerce platform that the user has secured a loan for payment for the purchase workflow.

2. The method of claim 1 wherein the security authentication check comprises:
receiving, by at least one computer processor and via the graphical user interface, the user's cellular telephone number;
generating, by at least one computer processor, a one-time password that is used to verify the user;
sending, by at least one computer processor and via SMS text messaging, the one-time password to the user's cellular telephone number; and
receiving, by at least one computer processor and via the graphical user interface, the one-time password that was received and input by the user to verify the user's identity.

3. The method of claim 2 further comprising encrypting, by at least one computer processor, the stored at least one answer set on a computer storable memory medium.

4. The method of claim 3 further comprising the steps of:
requesting, by at least one computer processor, a user's credit information from at least one credit bureau based on the at least one answer set;
receiving, by at least one computer processor, the at least one credit bureau's data corresponding to the user's credit information;
processing, by at least one computer processor and via a sorting algorithm, the user's credit information into a desired format;
determining, by at least one computer processor and via a minimum credit check criteria algorithm, whether the user's credit information meets a minimum credit check criteria; and
sending, by at least one computer processor, the user's credit information that meets the minimum credit check criteria with the at least one answer set and details of the user's desired purchase to the plurality of lenders that determines loan eligibility and terms based on the user's credit information and information provided by the user in the at least one answer set.

5. The method of claim 4 further comprising:
after receiving an approved loan application with corresponding terms from the lender, sending, by at least one computer processor, a verification token to the corresponding lender with the user's at least one answer set and details of the user's desired purchase to confirm the loan application approval and terms with that corresponding lender; and
prior to generating the list showing all approved loans with corresponding terms, receiving, by at least one computer processor, a verification confirmation from that corresponding lender that the loan application approval and terms are correct.

6. The method of claim 5 wherein the graphical user interface includes means for sorting and comparing the approved loan applications with corresponding terms and the user manipulating those means for sorting and comparing the approved loan application to aid the user's purchasing decision before the user selects their desired loan and terms.

7. The method of claim 6 further comprising a step wherein denying, by at least one computer processor and via the graphical user interface, the user's request for the loan and terms presents the user with a plurality of traditional payment options.

8. A computer system for simultaneous and multiple loan decision retrieval and presentation to a user who desires to complete a purchase workflow on an ecommerce platform comprising:
at least one computer processor; and
a program memory storing executable instructions that when executed by at least one computer processor causes the computer system to:
perform, by at least one computer processor and via a graphical user interface, a security authentication check to confirm the user's identity and establish a contact method for that user;
send, by at least one computer processor and via the graphical user interface, at least one set of questions that the user must answer;
receive, by at least one computer processor and via the graphical user interface, at least one answer set corresponding to the at least one set of questions that was sent to the user;
store, by at least one computer processor, the at least one answer set on a computer storable memory medium;
send, by at least one computer processor, the encrypted at least one answer set and details of the user's desired purchase to a plurality of lenders that determines loan eligibility and terms based on information provided by the user in the at least one answer set;
receive, by at least one computer processor, the loan application status and terms from the plurality of lenders within a predetermined timeframe;
generate, by at least one computer processor and via the graphical user interface, a list showing all approved loan applications with corresponding terms;
receive, by at least one computer processor and via the graphical user interface, the user's selected loan and terms;
forward, by at least one computer processor, the user to the lender's loan processing portal corresponding to the loan and terms the user selected;
receive, by at least one computer processor, a lender confirmation that corresponds to the user's acceptance of the loan and terms and the lender's approval of the user's acceptance;
receive, by at least one computer processor and via the graphical user interface, a submission by the user of a purchase confirmation; and
send, by at least one computer processor, the purchase confirmation to the ecommerce platform that the user has secured a loan for payment for the purchase workflow.

9. The computer system of claim 8 wherein the security authentication check comprises a program memory storing executable instructions that when executed by at least one computer processor causes the computer system to:
receive, by at least one computer processor and via the graphical user interface, the user's cellular telephone number;
generate, by at least one computer processor, a one-time password that is used to verify the user;
send, by at least one computer processor and via SMS text messaging, the one-time password to the user's cellular telephone number; and
receive, by at least one computer processor and via the graphical user interface, the one-time password that was received and input by the user to verify the user's identity.

10. The computer system of claim 9 further comprising a program memory storing executable instructions that when executed by at least one computer processor causes the computer system to encrypt, by at least one computer processor, the stored at least one answer set on a computer storable memory medium.

11. The computer system of claim 10 further comprising a program memory storing executable instructions that when executed by at least one computer processor causes the computer system to:
request, by at least one computer processor, a user's credit information from at least one credit bureau based on the at least one answer set;
receive, by at least one computer processor, the at least one credit bureau's data corresponding to the user's credit information;
process, by at least one computer processor and via a sorting algorithm, the user's credit information into a desired format;
determine, by at least one computer processor and via a minimum credit check criteria algorithm, whether the user's credit information meets a minimum credit check criteria; and
send, by at least one computer processor, the user's credit information that meets the minimum credit check criteria with the at least one answer set and details of the user's desired purchase to the plurality of lenders that determines loan eligibility and terms based on the user's credit information and information provided by the user in the at least one answer set.

12. The computer system of claim 11 further comprising a program memory storing executable instructions that when executed by at least one computer processor causes the computer system to:
after receiving an approved loan application with corresponding terms from the lender, send, by at least one computer processor, a verification token to the corresponding lender with the user's at least one answer set and details of the user's desired purchase to confirm the loan application approval and terms with that corresponding lender; and
prior to generating the list showing all approved loans with corresponding terms, receive, by at least one computer processor and, a verification confirmation from that corresponding lender that the loan application approval and terms are correct.

13. The computer system of claim 12 wherein the graphical user interface includes means for sorting and comparing the approved loan applications with corresponding terms that the user manipulates to aid the user's purchasing decision before the user selects their desired loan and terms.

14. The computer system of claim 11 further comprising a program memory storing executable instructions that when executed by at least one computer processor causes the computer system to:
deny, by at least one computer processor and via the graphical user interface, the user's request for the loan and terms; and
present, by at least one computer processor and via the graphical user interface, the user with a plurality of traditional payment options.

15. A non-transitory computer-readable storage medium comprising computer-readable instructions to be executed by at least one computer processors of a system for simultaneous and multiple loan decision retrieval and presentation to a user, the instructions when executed causes at least one computer processors to:
perform, by at least one computer processor and via a graphical user interface, a security authentication check to confirm the user's identity and establish a contact method for that user who desires to complete a purchase workflow on an ecommerce platform;
receive, by at least one computer processor and via the graphical user interface, at least one answer set corresponding to at least one set of questions provided to the user;
store, by at least one computer processor, the at least one answer set on a computer storable memory medium;
send, by at least one computer processor, the encrypted at least one answer set and details of the user's desired purchase to a plurality of lenders that determines loan eligibility and terms based on information provided by the user in the at least one answer set;
receive, by at least one computer processor, the loan application status and terms from the plurality of lenders within a predetermined timeframe;
generate, by at least one computer processor and via the graphical user interface, a list showing all approved loan applications with corresponding terms;
receive, by at least one computer processor and via the graphical user interface, the user's selected loan and terms;
forward, by at least one computer processor, the user to the lender's loan processing portal corresponding to the loan and terms the user selected;
receive, by at least one computer processor, a lender confirmation that corresponds to the user's acceptance of the loan and terms and the lender's approval of the user's acceptance;
receive, by at least one computer processor and via the graphical user interface, a submission by the user of a purchase confirmation; and
send, by at least one computer processor, the purchase confirmation to the ecommerce platform that the user has secured a loan for payment for the purchase workflow.

16. The non-transitory computer-readable storage medium of claim 15 wherein the security authentication check comprises a program memory storing executable instructions that when executed by at least one computer processor causes the computer system to:
receive, by at least one computer processor and via the graphical user interface, the user's cellular telephone number;
generate, by at least one computer processor, a one-time password that is used to verify the user;
send, by at least one computer processor and via SMS text messaging, the one-time password to the user's cellular telephone number; and
receive, by at least one computer processor and via the graphical user interface, the one-time password that was received and input by the user to verify the user's identity.

17. The non-transitory computer-readable storage medium of claim 16 further comprising a program memory storing executable instructions that when executed by at least one computer processor causes the computer system to encrypt, by at least one computer processor, the stored at least one answer set on a computer storable memory medium.

18. The non-transitory computer-readable storage medium of claim 17 further comprising a program memory storing executable instructions that when executed by at least one computer processor causes the computer system to:
request, by at least one computer processor, a user's credit information from at least one credit bureau based on the at least one answer set;
receive, by at least one computer processor, the at least one credit bureau's data corresponding to the user's credit information;
process, by at least one computer processor and via a sorting algorithm, the user's credit information into a desired format;
determine, by at least one computer processor and via a minimum credit check criteria algorithm, whether the user's credit information meets a minimum credit check criteria; and
send, by at least one computer processor, the user's credit information that meets the minimum credit check criteria with the at least one answer set and details of the user's desired purchase to the plurality of lenders that determines loan eligibility and terms based on the user's credit information and information provided by the user in the at least one answer set.

19. The non-transitory computer-readable storage medium of claim 18 further comprising a program memory storing executable instructions that when executed by at least one computer processor causes the computer system to:
after receiving an approved loan application with corresponding terms from the lender, send, by at least one computer processor, a verification token to the corresponding lender with the user's at least one answer set and details of the user's desired purchase to confirm the loan application approval and terms with that corresponding lender; and
prior to generating the list showing all approved loans with corresponding terms, receive, by at least one computer processor, a verification confirmation from that corresponding lender that the loan application approval and terms are correct.

20. The non-transitory computer-readable storage medium of claim 19 wherein the graphical user interface includes means for sorting and comparing the approved loan applications with corresponding terms that the user manipulates to aid the user's purchasing decision before the user selects their desired loan and terms.

21. The non-transitory computer-readable storage medium of claim 20 further comprising a program memory storing executable instructions that when executed by at least one computer processor causes the computer system to:
deny, by at least one computer processor and via the graphical user interface, the user's request for the loan and terms; and
present, by at least one computer processor and via the graphical user interface, the user with a plurality of traditional payment options.
